(19) United States
(12) Patent Application Publication
(10) Pub. No.: US 2015/0118142 A1
(43) Pub. Date: Apr. 30, 2015

(54) FORMATION OF CARBON NANOTUBE-ENHANCED FIBERS AND CARBON NANOTUBE-ENAHNCED HYBRID STRUCTURES

(71) Applicants: Christopher Allen Dyke, Houston, TX (US); Zohar Ophir, West Orange, NJ (US)

(72) Inventors: Christopher Allen Dyke, Houston, TX (US); Zohar Ophir, West Orange, NJ (US)

(21) Appl. No.: 13/261,982

(22) PCT Filed: Oct. 5, 2012
(86) PCT No.: PCT/GB2012/052476

§ 371 Date: Oct. 28, 2014

Related U.S. Application Data
(60) Provisional application No. 61/627,000, filed on Oct. 6, 2011.

(51) Int. Cl. D01F 9/22; D01F 9/24; C08K 9/04

(52) U.S. Cl. CPC D01F 9/22; C08K 9/04; D01F 9/24; D10B 2101/12
USPC 423/447.2; 524/186; 524/284; 524/391; 524/323; 524/392; 423/447.1

(57) ABSTRACT

Carbon fibers made by a process using a precursor that is a CNT/PAN material blend including CNTs functionalized with a nucleophilic material; and carbon fibers made with such a process.

### FIELD OF THE INVENTION

The present invention is directed to: processes for the dry-jet wet spinning of fibers; such processes for the production of carbon fiber; in certain aspects, such processes using as a spinning dope a precursor which is a mixture of carbon nanotubes dispersed in polyacryonitrile (PAN) material; such processes in which the carbon nanotubes are functionalized with nucleophilic material; carbon fibers made with any such process; and carbon nanotube/graphene hybrids.

### BACKGROUND TO THE INVENTION

Carbon fibers, often defined as a fiber with at least 92 wt % carbon, have desirable mechanical properties and are used in a very wide variety of articles, including composites, textiles, and structural parts.

In general, different precursors produce carbon fibers with different properties. Polyacrylonitirle (PAN) carbon fibers are made from a PAN precursor. Although producing carbon fibers from different precursors requires different processing conditions, the features of many processes are similar and in these processes carbon fibers are made by a controlled pyrolysis of stabilized precursor fibers. For example, precursor fibers arc first stabilized at about 200-400° C. in air by an oxidization process. The infusible, stabilized fibers are then subjected to a high temperature treatment at around 1,000° C. in an inert atmosphere to remove hydrogen, oxygen, nitrogen, and other non-carbon elements. This step is often called carbonization. Carbonized fibers can be further graphitized at an even higher temperature up to around 3,000° C. to achieve higher carbon content and higher Young's modulus in the fiber direction.

The properties of the resultant carbon/graphite fibers are affected by many factors such as crystallinity, crystalline distribution, molecular orientation, carbon content, and the amount of defects. In terms of final mechanical properties, carbon fibers can be roughly classified into ultra-high modulus (>500 GPa), high modulus (>300 GPa), intermediate modulus (>200 GPa), low modulus (100 GPa), and high strength (>4 GPa) carbon fibers. Carbon fibers can also be classified, based on final heat treatment temperatures, into type I (2,000° C. heat treatment), type II (1,500° C. heat treatment), and type 111 (1,000° C. heat treatment). Type II PAN carbon fibers are usually high strength carbon fibers, while many of the high modulus carbon fibers belong to type I.

Polyacrylonitrile (PAN) is a known and widely used precursor for making carbon fibers. PAN can be polymerized from acrylonitrile (AN) by commonly used radical initiators, such as peroxides and azo compounds, through the addition polymerization process. The process can be a solution polymerization process or a suspension polymerization process. Solution polymerization is often preferred so that the produced PAN solution can be used as a fiber spinning dope directly, once unreacted monomers arc removed. This eliminates PAN drying and redissolving processes. The solvent has a low chain transfer coefficient in order to produce PAN with increased molecular weights. Some commonly used solvents are dimethyl sulfoxide, ZnCl₂ and NaSCN. Often, an approximate 5 mol % of co-monomers (e.g. methyl acrylate and vinyl acetate) are incorporated as internal plasticizers to reduce intermolecular interaction to improve the solubility of PAN polymer and the processability of PAN precursor fibers.

It is known that the incorporation of a co-monomer can also improve the carbon fiber mechanical properties due to increased molecular orientation in precursor fibers and the resultant carbon fibers. Some co-monomers, especially those with acidic groups (e.g. acrylic acid or itaconic acid) or acrylamide, facilitate the cyclization reaction in the stabilization step and, for that purpose, 0.4-1 mol % can be incorporated in the copolymer.

Traditional wet spinning has been widely used to produce PAN precursor fibers, as well as dry-jet wet spinning, to spin a dope with higher polymer concentrations and produce carbon fibers with better mechanical properties. In wet spinning, PAN is first dissolved into a highly polar solvent, such as dimethyl sulfoxide, dimethyl formamide, dimethyl acetamide, sodium thiocyanate or their mixtures, to form a solution of, e.g., 10-30 wt % solids. PAN solution is then filtered and extruded. The extruded PAN goes through a coagulation bath consisting of a PAN solvent and a non-solvent. Fibers are consolidated when the solvent diffuses away from the precursor. Fiber bundles are under tension in the coagulation bath to achieve the molecular alignment. The higher the concentration of the nonsolvent and the higher the temperature of the coagulation bath, the higher is the coagulation rate.

In a wet spinning process, a low coagulation rate is often preferred to macrovoids extending from the outer edge to the center of the fiber. A low coagulation rate can also suppress the formation of unpreferred skin-core structure.

In some known processes, with a high concentration of solvent in the coagulation bath, fibers in a gel state are formed. Orientation can be achieved in this state. The PAN precursors pass though several baths with different temperatures and compositions to allow better molecular orientation in the precursor fibers. The residence time in the bath can be as short as 10 seconds.

The coagulated fibers are then washed and further stretched to remove excess solvent in the fibers and increase the molecular orientation. In some aspects, fibers are drawn at a temperature between 130° C. to 150° C. by using steam, hot plates, and heated godets or glycerol baths. Further increases in tensile properties are observed as the draw ratio increases.

There are a wide variety of known systems and processes for making carbon fibers, for dry-jet wet spinning, and for dry-jet wet spinning of carbon fibers, some examples of which are in these exemplary U.S. patents and applications: U.S. Pat. Nos. 7,906,208; 7,425,368; 6,852,410; 6,290,888; 6,242,093; 5,968,432; 5,234,651; 3,996,321; 3,842,151; 3,767,756; and 3,412,191—all of which are incorporated fully herein for all purposes.

“Functionalization” is the addition of one or more specified chemicals or chemical groups to a basic structure. The functionalization of nanotubes is the desired chemical modification of nanotubes to alter their chemical properties. Typically, functionalization involves the bonding of chemical moieties onto carbon nanotubes.

A variety of attempts to disperse carbon nanotubes have met with processing obstacles that inhibit or prevent desired enhancement of polymers and composites using incorporated nanotubes. In certain methods, functionalization is advantageous for property enhancement when nanotubes are blended with polymers. Due to intrinsic van der Waals attraction between nanotubes, and by virtue of their high aspect ratio (e.g., about 1:1000), nanotubes are typically agglomerated along their lengths, e.g. stick together as bundles and ropes, that have very low solubility in most solvents. In many instances, despite processing to achieve individual particles, nanotubes tend to remain as entangled agglomerates and homogeneous dispersion is not easily obtained. Furthermore, due to the atomically smooth non-reactive surface of nanotubes, lack of interfacial bonding limits load transfer from the matrix to nanotubes. Nanotubes are often pulled from a matrix along a fracture, and play a limited role in mechanical reinforcement of a composite structure.

There are a wide variety of known functionalized nanotubes and of functionalization processes some examples of which are in these exemplary U.S. patent applications: U.S. Patent Applications Pub. Nos. 2011/0174701; 2006/0135030; 2009/0099276—all of which are incorporated fully herein for all purposes along with all references in each of these.

### SUMMARY OF THE INVENTION

The present invention, in certain aspects, discloses processes for the formation of carbon nanotube-enhanced carbon fibers; and the formation of new carbon nanotube/graphite hybrid structures. Functionalized carbon nanotubes are used in these processes.

In certain aspects, the present invention discloses processes for producing carbon fibers which use carbon nanotubes functionalized with a nucleophilic organic material covalently appended to the nanotube, in one aspect, to a nanotube sidewall. In certain particular aspects, the carbon nanotubes are functionalized with carboxylic acid.

In one particular aspect, the carbon nanotubes (“CNT”) are functionalized by acid treatment or oxidation of the CNT with a mixture of a strong acid, e.g., sulfuric acid, and a strong oxidizer/acid, e.g., nitric acid, in a reaction mixture heated to 80° C. and sonicated, e.g., for 1 to 5 hours. This treatment results in the appending of carboxylic acids on ends and sidewalls of CNT.

The present invention discloses carbon fibers made with a dry-jet wet spinning process that uses as a precursor a nanotube/PAN-material blend—a mixture of functionalized carbon nanotubes dispersed in a polyacrylonitrile or “PAN” material which can be PAN; PAN copolymers; including, but not limited to, PAN/MA, PAN/methylacrylate, and PAN/MA/IA, PAN/methyl acrylate/itaconic acid.

The present invention, in certain aspects, discloses processes and carbon fibers made with a process that includes: formation of a carbon nanotube/PAN blend (“CNT/PAN blend”); dry-jet wet spinning of a solution (“spining dope”) with the blend producing as-spun fibers; drawing of the as-spun fibers; stabilization; and carbonization to produce end-product carbon fibers. In certain aspects, the carbon nanotubes are functionalized with an organic group terminated by a nucleophile.

In certain aspects, described in detail below, the CNT/PAN blend is made by dispersing nanotubes in a solvent producing a solution with the blend; adding dissolved PAN material to the solution; and concentrating the blend to a desired concentration. This produces a spinning solution for dry-jet wet spinning.

Certain processes according to the present invention include: producing a CNT/PAN blend according to the present invention; spinning filaments from the CNT/PAN blend (the blend serves as a “precursor”); drawing the spun filaments; stabilizing the drawn filaments; and carbonizing the stabilized filaments; (and, optionally, graphitizing the carbonized filaments) producing carbon fibers. Multiple coagulating steps, multiple drawing steps and/or multiple carbonizing steps may be employed.

Carbon fibers produced with processes according to the present invention exhibit improved electrical and thermal properties, such as increases in electrical and thermal conductivity, and improved mechanical properties, such as increases in Young's modulus and tensile strength. These improved properties are due to the presence of carbon nanotubes in the end-product carbon fibers and due to covalent attachment of CNTs to graphene sheets in the fibers. This structure is due to the initial attachment of the CNT to the PAN precursor during the stabilization stage of the process.

Processes according to the present invention produce CNT/graphite hybrid fibers when the drawn fibers are carbonized. During the carbonization, graphitic sheets are formed as the functional groups (nucleophilic material) appended to the CNT sidewalls are expelled (e.g., at temperatures between 500° C. and 1000° C.). This forms a highly reactive carbon nanotube radical in close proximity to the being-formed and forming graphitic and/or turbostratic carbon sheets. The carbon nanotube radical reacts with the structure of the sheets rendering CNTs covalently embedded in the carbon ring structure of the sheets. Further heat treatment at a temperature between 1800 to 3000° C. completes the process to form a CNT/graphite hybrid fiber.

Accordingly, the present invention includes features and advantages which are believed to enable it to advance CNT/graphite hybrid fiber technology and dry-jet wet spinning carbon fiber production technology. Characteristics and advantages of the present invention described above and additional features and benefits will be readily apparent to those skilled in the art upon consideration of the following detailed description of preferred embodiments and referring to the accompanying drawings.

New, useful, unique, efficient, nonobvious carbon fibers and processes for making them are disclosed. Such processes are enhanced by using CNTs functionalized with nucleophilic material.

### BRIEF DESCRIPTION OF THE DRAWINGS

How the invention may be put into effect will be described below, by way of example only, with reference to the accompanying drawings, in which similar parts may be referred to by the same reference numerals, and:

FIG. 1 presents in schematic form a summary of a process according to the present invention.

FIG. 2 presents in schematic form a summary of a process according to the present invention.

### DESCRIPTION OF PREFERRED EMBODIMENTS

As regards the polyacrylonitrile component of the organogel, “PAN” includes homopolymers and copolymers of polyacrylonitrile with one or more than one co-monomer (e.g. a terpolymer), including, but not limited to, PAN/MA (PAN/methylacrylate) and PAN/MA/IA (PAN/methyl acrylate/itaconic acid). As explained above, up to about 5 mol % of co-monomers (e.g. methyl acrylate and vinyl acetate) may be incorporated as internal plasticizers to reduce intermolecular interaction, to improve the solubility of PAN polymer and the processability of PAN precursor fibers and to improve the carbon fiber mechanical properties due to increased molecular orientation in precursor fibers and the resultant carbon fibers. Some co-monomers, especially those with acidic groups (e.g. acrylic acid or itaconic acid) or acrylamide, facilitate the cyclization reaction in a subsequent stabilization step and, for that purpose, 0.4-1 mol % can be incorporated in the copolymer. As regards molecular weight, gel formation and gel spinning have been reported with linear PAN of ultra-high molecular weight, see U.S. Pat. No. 4,883,628 (Kwock) but only with PAN having a weight average molecular weight>500,000 and in embodiments 1,000,000-4,000,000 e.g. 1,500,000-2,500,000 and with a relatively narrow range of concentrations or solid loadings of PAN in the selected solvent or dispersant e.g. 2-15 wt % and with recommended temperatures at which the gel is to be extruded of 130-200° C. which is undesirably close to the boiling points of the solvent or dispersant e.g. DMSO. The molecular weights of the PAN homopolymer or copolymers used herein may in some embodiments be above those used for the forming of conventional textile fibers but less than the ultra-high molecular weight grades employed by Kwock e.g. weight average molecular weights of 80,000-150,000, in many embodiments about 100,000. The PAN homopolymer or copolymers with molecular weights in this range may not spontaneously form gels when dissolved or dispersed in the solvent or dispersant, but in that case may be induced to form gel by addition of water as described below. Use of lower molecular weight grades of PAN enables higher solid loadings of PAN in the solvent or dispersant.

In one particular aspect, the CNTs are functionalized by an acid treatment is conducted by first dispersing unreacted carbon nanotubes in sulfuric acid by homogenization and/or sonication. To this solution, nitric acid (a strong oxidizer) is added. The reaction mixture is then heated to 80° C. in a sonication bath for 1 to 5 hours. This produces carboxylic acid functionalized CNT which are then purified to remove residual metal and organic contamination. In one particular aspect, a CNT/PAN blend according to the present invention is made by first dispersing the functionalized CNT in a polar solvent such as DMF by homogenization then sonication. Typically an excess of solvent is used to disperse the agglomerated bundles of CNT as individuals. To the CNT/DMF solution is added the dissolved PAN. The PAN is typically dissolved in the spinning solution (DMF or DMSO) and dissolved before introduction to the CNT solution. Once the ingredients are mixed, the solution is concentrated in vacuo to the proper weight % solids concentration. This is typically from 20 to 30 wt. % solids. Water is added to the warmed CNT/PAN spinning solution, e.g., water at 1 to 5 wt. %, to form a thermoreversible gel.

In certain embodiments, the sol-gel transition temperature should be sufficiently low so that the material is in the liquid state in the spinning head, while sufficiently high to form a gel as the material leaves the spinning head e.g. about 70—less than 130° C. e.g. about 80-90° C. e.g. about 80° C. To facilitate reversion to the gel state, extrusion. in some embodiments is at a temperature that is close to the sol-gel transition point so that virtually as soon as the fibers are extruded into lower temperature air they start to revert to the gel state. The applicants have observed in some embodiments sol-gel transition temperatures varying from 70 to 100° C. The material may be warmed above this temperature and poured into the spinning head. The spinning head. and spinneret, composed of metal, may then be held at a temperature slightly above the transition temperature (varies depending on composition of material). Once the solution is forced out of the spinning head, it enters an air gap which is a zone between spinning head and a first downstream treatment station e.g. a coagulation bath. The air gap is maintained at ambient temperature and pressure. The material leaves the heat source (or spinning head) and cools to a temperature below the sol-gel transition temperature. In effect, the material transitions from solution to gel in the air gap as it cools.

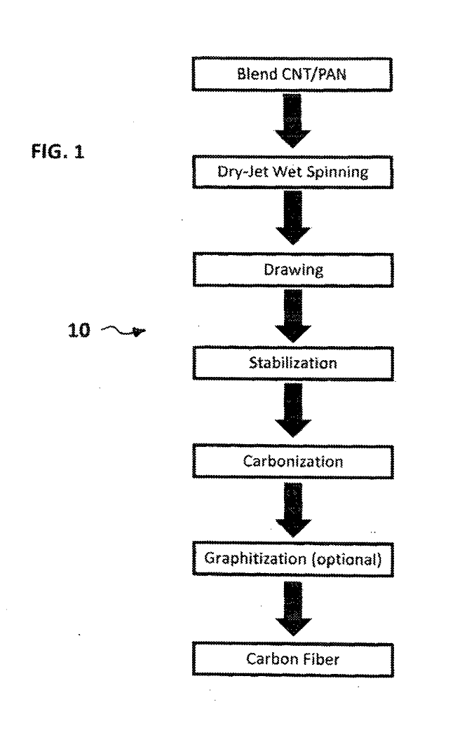

FIG. 1 shows schematically steps in a process 10 according to the present invention for producing carbon fibers. A blend (“Blend CNT/PAN”) is made of functionalized carbon nanotubes (“CNTs”) dispersed in PAN material, the nanotubes functionalized with a nucleophilic material. A spinning solution (“Spinning Dope”) is then made by dissolving the blend in a solvent. Water (1 to 5 wt. %) is then introduced to the spinning solution to form a thermoreversible gel. This gel is the “spinning dope” for a dry-jet wet spinning process (“Dry-Jet Wet Spinning”) that produces as-spun fibers made from the CNTs and the PAN material. The dry-jet wet spinning includes a coagulation bath or baths to remove solvent from the as-spun fibers to facilitate the formation of fibers.

The as-spun fibers arc drawn (“Drawing”) or stretched to achieve desired molecular alignment of PAN (with the CNTs in the PAN) and to decrease molecular interatomic spacing. This produces drawn fibers.

The drawn fibers are then stabilized (“Stabilization”) using a stabilization process according to the present invention. Stabilization includes cyclization, dehydrogenation, and oxidation of the oriented PAN/CNT material. Stabilization can include placing the fibers under tension while they are heated, e.g., in air. This produces stabilized fibers.

The stabilized fibers are converted (carbonized) to carbon fibers by pyrolysis of the stabilized fiber (“Carbonization”) with a high temperature treatment in an inert atmosphere; and then, optionally, graphitized (“Graphitization”) using heating temperatures higher than those of the carbonization step.

According to the present invention, a CNT/graphite-fiber precursor is a material in which CNT is covalently attached to a stabilized PAN product. A “stabilized PAN product” is the product of a stabilization process step as described above. The drawn fibers that are subjected to stabilization include functionalized nanotubes that are nucleophile-terminated CNT.

During stabilization, the nucleophilic material appended to the CNTs initiates cyclization via an ionic mechanism (at a relatively lower stabilization temperature than stabilization done without the nucleophilic material). This cyclization reaction occurs before the PAN free radical cyclization and results in the formation of covalent bonds between CNTs and cyclized PAN. This bond formation is facilitated by drawing the as-spun fibers—which decreases the d-spacing.

In certain aspects, the draw ratios are approximately 36. The d-spacing is the interatomic distance between PAN compounds. In certain aspects, it is desirable that the CNTs and PAN material are in close proximity or intimate contact which facilitates CNT-initiated cyclization to occur. Intimate contact is described as two atoms separated by a negligible distance, such as 1 Å.

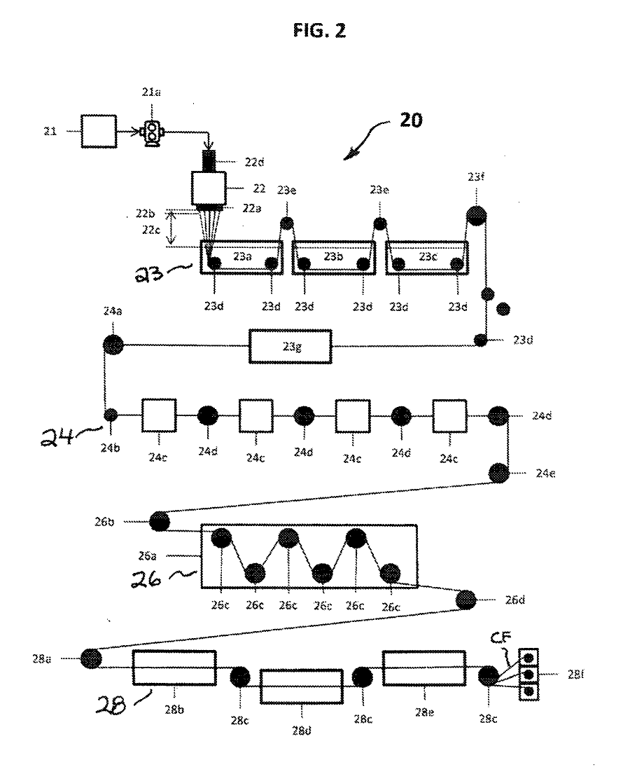

FIG. 2 presents schematically a process 20 according to the present invention. Spinning dope according to the present invention is heated in a vessel 21 and transferred to a spinning head 22. The spinning solution passes from the spinning head 22 to form filaments 22b. These filaments 22b pass through an air gap to a coagulation system 23 and then to a drawing system 24. From the drawing system 24, the fibers are introduced to a stabilization system 26. Following stabilization, the fibers are carbonized in a carbonization system 28 whose output is carbon fibers CF.

A pump system 21a pumps spinning dope from the heated vessel 21 to a spinning head 22. In one particular embodiment, the spinning dope is pumped at an approximate rate of 100 mL/min and at a temperature of 80° C.

Spun filaments 22b exit the spinning head 22 passing through a multi-hole spinneret 22a and flow into an air gap 22c which is maintained at room temperature, e.g., about 25° C. The filaments are cooled in the air gap and convert from a solution to a gel. The filaments are forced through the spinneret 22a by a plunger system 22d. The resulting fibers pass through three coagulation baths 23a, 23b, 23c with guide rollers 23d in the baths and drawing motors 23e and 23f above the baths. The fibers are then fed from a take-up roller 23g to a payout spool 24a of the drawing system 24. The coagulation baths contain a mixture of the polar spinning solvent and the non-solvent (e.g., water). The temperature of each bath is maintained at approximately room temperature to decrease the rate of diffusion of the polar spinning solvent. The RPM of the drawing motors 23e and the take-up roller 23f is adjusted to give a draw ratio of between 4 and 9. The fiber is then passed through a drier to the drawing system 24.

From the payout spool 24a, the fibers arc pulled around a guide roller 24b and through a series of heating blocks 24c by heated drawing rollers 24d. The drawn fiber is then collected on a take-up spool 24e. In one aspect, each drawing apparatus has a heated godet drawing roller 24d and a hot plate shoe 24c. The temperature of the heating blocks and heated rollers is between 100° C. and 180° C. The RPM of the rollers is adjusted to give a draw ratio of typically between 5 and 12.

A payout spool 26b in the stabilization system 26 receives the fibers from the take-up roller 24e in the drawing system 24. The fibers are tensioned by tensioning stations 26c-26 through a stabilization furnace 26a. The temperature of the furnace is increased by 1 to 2° C/min to a maximum temperature of between 200 and 300° C. The maximum temperature varies depending on the particular fiber precursor.

In processes according to the present invention which employ nucleophile-terminated functionalized CNTs, the nucleophile of the nucleophilic functional group initiates cyclization via an ionic mechanism at a relatively lower temperature than with certain known processes. Also, if the CNT/Pan fiber is highly drawn, this reaction—cyclization—occurs first and a covalent bond is formed between CNTs and cyclized PAN material.

The tensioning is controlled by adjusting the rate of rotation, RPMs, of the spools at each tensioning station such that entropic shrinkage of the fiber is mitigated and the fiber is drawn in the furnace to a maximum of 30% strain.

Pyrolysis of the stabilized fiber converts the PAN material with CNTs precursor to carbon fibers. Non-carbon atoms are driven off in the form of small organics, such as HCN and N2 and, by heating the fibers in the carbonization/graphitization furnace system 28. A payout system 28a receives the fibers from the stabilization system 26. The stabilized fibers are heat-treated in an inert (nonoxidizing) atmosphere at temperatures between 800° C. and 1400° C. in a carbonization furnace 28b. The fibers are drawn through the furnace by a heated tensioning roller 28c so as to heat the fibers at a maximum rate of 5° C/min. The fibers are then drawn by a tensioning roller 28c through a high temperature furnace 28d with a maximum temperature of 1600° C. Heteroatoms in the fibers are expelled in this heating step. This gives carbon fiber composed essentially of carbon.

The carbon fiber can be additionally graphitized. Graphitization is conducted by drawing the carbon fiber through an ultra-high temperature furnace 28e by a heated tensioning roller 28c. This furnace is at a temperature between 1800° C. and 3000° C. This further heat treatment or graphitization anneals the turbostratic carbon structure of the fibers thus forming graphite sheets. Without being held to any theory, it is believed that the stabilized fibers dimerize by ring condensation. As nitrogen continues to be expelled, carbon sheets continue to be formed.

Further heat treatment (from 1800 to 3000° C.) leads to conversion of turbostratic carbon sheets to graphene sheets thus completing the process and a CNT/graphite hybrid fiber is formed. The carbon fibers are finally collected on spools by a winding system 28f.

The finished carbon fibers made by this embodiment of the process 20 are from 90% to 99% carbon. The carbon fibers, in certain embodiments, are 5 μm in diameter with an approximate weight per length value of 0.04 g per 1000 m.

Certain CNT/graphite hybrid fibers according to the present invention have a unique morphology with increases in modulus, electrical and thermal conductivity. Inherent to the CNT and PAN carbon fiber precursors, are expected additional increases in tensile strength. In addition, CNT absorbs microwaves; therefore, by the introduction of CNT leads to radar absorption. In certain aspects, this makes possible low observable composite structures.

1.-23. (canceled)

24. A precursor for making carbon fibers, the precursor comprising a blend of nucleophile-terminated functionalized carbon nanotubes and polyacrylonitrile material.

25. The precursor of claim 24, wherein the nucleophile-terminated functionalized carbon nanotubes are functionalized with an organic compound with a nucleophilic subunit; the nucleophilic subunit being one of a carboxylic acid, an alcohol, a phenol, an amine, and/or a thiol and/or a combination of two or more of these.

26. The precursor of claim 24, wherein the polyacrylonitrile material is one of PAN, copolymers of polyacrylonitirle, PAN/MA (PAN/methylacrylate) and PAN/MA/I A (PAN/methyl acrylate/itaconic acid).

27. The precursor of claim 24 further comprising a polar solvent and an amount of water effective to form a gel, the gel comprising a thermoreversible gel.

28. The precursor of claim 27, wherein the gel is an organogel comprising a polyacrylonitrile material having a weight average molecular weight which is one of 80,000-150,000 and about 100,000.

29. The precursor of claims 28, wherein the organogel has a sol-gel transition temperature which is one of: 70-130 ° C.; 80-90 ° C.; about 80° C.

30. The precursor of claim 24, wherein the polyacrylonitrile is a homopolymer.

31. The precursor of claims 24, wherein the polyacrylonitrile material is a copolymer or terpolymer of acrylonitrile with at least one polymerizable monomer having an alkenyl group and one or two carboxylic acid or ester groups per molecule.

32. The precursor of claim 31, wherein the polyacrylonitrile is one of PAN/MA (PAN/methylacrylate) and PAN/MA/IA (PAN/methyl acrylate/itaconic acid).

33. The precursor of claim 24 comprising 20-30 wt % solids.

34. The precursor of claims 27 comprising 1-5 wt % water.

35. A process for making carbon fibers, the process comprising
with spinning apparatus, spinning filaments from a spinning dope with a precursor to produce spun filaments, the precursor comprising blend of nucleophile-terminated functionalized carbon nanotubes and polyacrylonitrile material,
drawing the spun filaments producing drawn filaments,
stabilizing the drawn filaments producing stabilized filaments, and
carbonizing the stabilized filaments producing carbon fibers.

36. The process of claim 35, further comprising graphitizing the carbon fibers after carbonizing.

37. The process of claim 35, wherein drawing is done in multiple drawing steps.

38. The process of claim 35, further comprising coagulating the carbon fibers.

39. The process of claim 38, wherein the coagulating is done in multiple coagulating steps

40. The process of claim 35, wherein the carbonizing is done in multiple carbonizing steps.

41. The process of any of claim 35, further comprising bathing the spun filaments in at least one coagulation bath or in multiple coagulation baths removing solvent from the spun filaments to facilitate fiber formation.

42. Carbon fibers made by a process for making carbon fibers, the process comprising
with spinning apparatus, spinning filaments from a spinning dope with a precursor to produce spun filaments, the precursor comprising blend of nucleophile terminated functionalized carbon nanotubes and polyacrylonitrile material,
drawing the spun filaments producing drawn filaments,
stabilizing the drawn filaments producing stabilized filaments, and
carbonizing the stabilized filaments producing carbon fibers.

43. The carbon fibers of claim 42, the process further comprising making the carbon fibers CNT/graphite hybrid fibers.
